(19) United States
(12) Patent Application Publication
(10) Pub. No.: US 2014/0190823 A1
(43) Pub. Date: Jul. 10, 2014

(54) BIOSENSOR

(71) Applicant: Samsung Electronics Co., Ltd., Suwon-si (KR)

(72) Inventors: Chul-Ho CHO, Seongnam-si (KR); Jae-Hong KIM, Incheon (KR); Su-Ho LEE, Suwon-si (KR)

(73) Assignee: Samsung Electronics Co., Ltd., Suwon-si (KR)

(21) Appl. No.: 14/149,283

(22) Filed: Jan. 7, 2014

(30) Foreign Application Priority Data
Jan. 8, 2013 (KR) 10-2013-0002270

(51) Int. Cl. G01N 27/327

(52) U.S. Cl. CPC G01N 27/327
USPC 204/403.01

(57) ABSTRACT

A biosensor is provided. The biosensor includes a base plate including a detector configured to detect a sample through an electrode, an insulation layer disposed on a top surface of the base plate, a top plate mounted over the base plate and including a sample inlet that introduces the sample onto the detector, and a spacer interposed between the top plate and the insulation layer and forming a chamber.

### CROSS-REFERENCE TO RELATED APPLICATION(S)

This application claims the benefit under 35 U.S.C. §119(a) of a Korean patent application filed on Jan. 8, 2013 in the Korean Intellectual Property Office and assigned Serial number 10-2013-0002270, the entire disclosure of which is hereby incorporated by reference.

### TECHNICAL FIELD

The present disclosure relates to a biosensor. More particularly, the present disclosure relates to a biosensor for introducing a sample and detecting information about the sample.

### BACKGROUND

When a fluid sample is examined for clinical diagnosis and/or environment monitoring, one of various devices used to analyze a sample is a biosensor that uses an electrochemical test sensor. Particularly, insulin-dependent diabetic patients use biosensors to periodically self-monitor the blood glucose of a sample, while carrying the biosensors. A sufficient amount of a sample needs to be provided accurately to a detection position of a biosensor to allow reaction to occur at an electrode of the biosensor and/or at a detection position of the biosensor. A sample inlet having a narrow fluid path is formed on the front of the biosensor in order to receive the sample and transfer the sample to the detection position. When the sample is provided to the sample inlet having the narrow fluid path, the sample is transferred to the detection position through a capillary phenomenon of the narrow fluid path. The biosensor with the sample inlet and the narrow path also includes a top plate and a lower plate, each having an electrode printed thereon and a guide plate interposed between the upper and lower plates, which forms the narrow fluid path to provide a sample to a detection position, and the sample inlet. Biosensors of the related art are disclosed in Korean Patent No. 10-1191093 entitled “Fluid Testing Sensor Having Bents for Directing Fluid Flow”, registered on Oct. 9, 2012, and Korean Patent No. 10-0854389 entitled “Electrochemical Biosensor”, registered on Aug. 20, 2008.

In a biosensor of the related art, however, a sample inlet is formed to be very narrow in order to suck in a sample placed on the front of the biosensor and transfer the sample to a detection position. Thus a user may have difficulty in placing a sample in the very narrow sample inlet and the sample inlet may overflow with the sample due to the sample being larger than the sample inlet, even though the sample is placed in the sample inlet. Moreover, since the amount of a sample overflowing the sample inlet is larger than the amount of a sample placed at the detection position through the sample inlet, the sample may not be provided sufficiently to the detection position. As a result, the biosensor may not detect sufficient information about the sample and the detected information may not be analyzed accurately. Such a biosensor, which may not provide accurate information, is not reused and thus is replaced with a new biosensor. Using the new biosensor may not be cost-effective and the user may need to take a new sample, for example, and thus, may need to inconveniently draw more blood.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a biosensor for increasing user convenience.

Another aspect of the present disclosure is to provide a biosensor for facilitating introduction of a sample and transferring a sufficient amount of a sample to a detection position.

In accordance with an aspect of the present disclosure, a biosensor is provided. The biosensor includes a base plate including a detector configured to detect a sample through an electrode, an insulation layer disposed on a top surface of the base plate, a top plate mounted over the base plate and including a sample inlet that introduces the sample onto the detector, and a spacer interposed between the top plate and the insulation layer and forming a chamber.

In accordance with another aspect of the present disclosure, a biosensor in which a sample inlet has a plurality of holes on a top surface of a top plate, wherein a sample is transferred to a detector of a base plate, which is disposed under the sample inlet, through the plurality of holes is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is an exploded view of a biosensor according to an embodiment of the present disclosure;

FIG. 2 is an assembled view of the biosensor illustrated in FIG. 1 according to an embodiment of the present disclosure;

FIG. 3 is a front view of the biosensor illustrated in FIG. 1 according to an embodiment of the present disclosure;

FIG. 4 is a sectional view of the biosensor illustrated in FIG. 1, taken along line A-A′ according to an embodiment of the present disclosure; and

FIGS. 5A, 5B, 5C, and 5D illustrate a spotted state of a sample on the biosensor illustrated in FIG. 2 according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

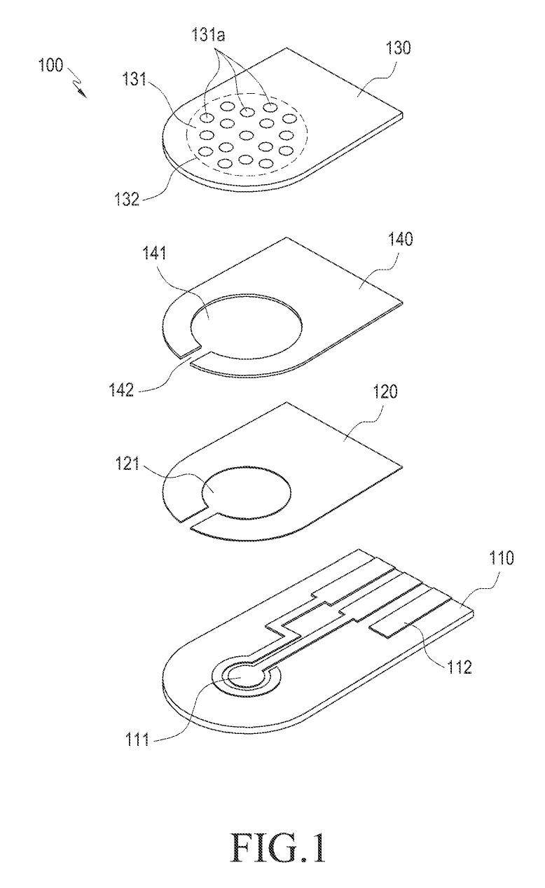

A biosensor of the present disclosure is characterized according to features wherein the biosensor facilitates introduction of a prepared sample and transfers most of the prepared sample to a detector without an overflow of the sample beyond the biosensor. The biosensor of the present disclosure will be described below with reference to FIGS. 1 to 5D.

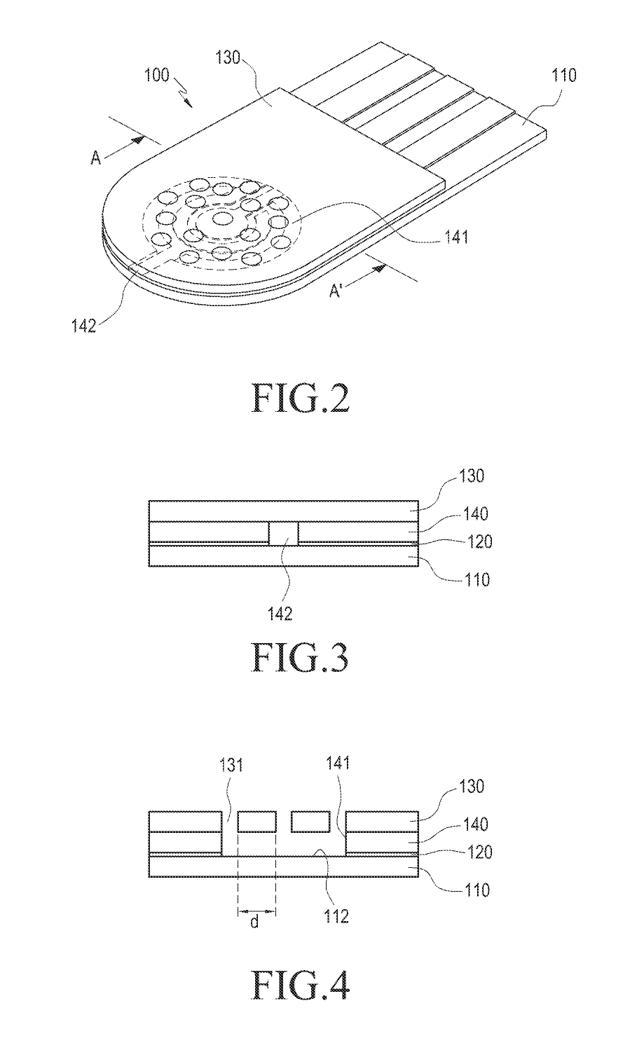

FIG. 1 is an exploded view of a biosensor according to an embodiment of the present disclosure; and FIG. 2 is an assembled view of the biosensor illustrated in FIG. 1 according to an embodiment of the present disclosure.

Referring to FIGS. 1 and 2, a biosensor 100 of the present disclosure includes a base plate 110, an insulation layer 120, a top plate 130, and a spacer 140. The base plate 110 includes a detector 111 that detects information about a sample introduced from above, such as from a sample inlet 131 formed in the top plate 130, through the detector 111. The insulation layer 120 is provided on the top surface of the base plate 110, to prevent a sample from contacting an electrode unit 112, except for around the detector 111. A hole 121 is formed into the insulation layer 120, in correspondence with the position of the detector 111, and more specifically, at the position of a chamber 141 that forms a space into which a sample is introduced. The spacer 140 is interposed between the insulation layer 120 and the top plate 130 and the chamber 141 is formed in the spacer 140 to fill a sample at the position of the detector 111. That is, the spacer 140 includes the chamber 141 between the top plate 130 and the base plate 110, wherein the spacer 140 is a space to be filled with a sample on the detector 111.

FIG. 3 is a front view of the biosensor illustrated in FIG. 1 according to an embodiment of the present disclosure.

Referring to FIGS. 1 to 3, at least one vent hole 142 communicating with the chamber is shown on the front of the biosensor. As shown in FIG. 3, the at least one vent hole 142 is formed in the spacer 140 in such a manner that the vent hole 142 communicates with, or, in other words, is connected to, the chamber 141 and thus the chamber 141 communicates with, or, in other words, is connected to, the outside of the biosensor 100. When the insulation layer 120, the spacer 140, and the top plate 130 are sequentially stacked on the base plate 110, the vent hole 142 is positioned on a side surface of the biosensor 100. If a sample is introduced through the sample inlet 131 on the top of the biosensor 100, then the air filled in the space of the chamber 141 is discharged through the vent hole 142 on the side surface of the biosensor 100, thereby facilitating introduction of the sample. According to the present disclosure, since a plurality of holes 131a are provided in the sample inlet 131, when a sample is spotted, or in other words, disposed and/or placed, on the biosensor 100, some of the plurality of holes 131a, at the spotted position, introduce the sample into the chamber 141, while remaining ones of the plurality of holes 131a, at positions where the sample is not spotted, discharge the air from the chamber 141 through the vent hole 142. Therefore, the sample is readily introduced into the chamber 141.

FIG. 4 is a sectional view of the biosensor illustrated in FIG. 1, taken along line A-A′ according to an embodiment of the present disclosure.

Referring to FIGS. 1 to 4, the top plate 130 is mounted on the spacer 140 above the base plate 110 so that the top plate 130 may be on the top of the biosensor 100. The sample inlet 131 having the plurality of holes 131 a is formed in the top plate 130, facing the top surface of the detector 111. The biosensor 100 is formed by sequentially stacking the insulation layer 120, the spacer 140, and the top plate 130 on the base plate 110. Thus the sample inlet 131, the chamber 141, and the detector 111 are stacked vertically on the base plate 110, in order to communicate with one another. Since the sample inlet 131 is configured on the top surface of the top plate 130 to allow the chamber 141 to communicate with the outside of the biosensor 100, the sample is readily introduced through the sample inlet 131 having the plurality of holes 131a formed over a wide area of the top plate 130 and filled in the chamber 141 on the top surface of the detector 111, and the detector 111 detects information about the sample filled in the chamber 141.

The plurality of holes 131 a provided in the sample inlet 131 penetrate through the top plate 130, facing the chamber 141. The plurality of holes 131a are formed in correspondence with the positions of the detector 111 and the chamber 141. When the sample is spotted on the top plate 130, the sample is all introduced into the chamber 141 through the plurality of holes 131a, thus filling the detector 111. The sample inlet 131 communicates with the detector 111 and the chamber 141 and a position and a size of the sample inlet 131 on the top plate 130 are approximate to the position and size of the chamber 141. Additionally, a part of the top plate 130 in which the holes 131a are formed, specifically a part of the top plate 130 corresponding to the size of the chamber 141, may be referred to as an opening part 132.

Thus, when the sample is placed on the opening part 132, the sample is introduced into the chamber 141 through the sample inlet 131 formed in the opening part 132, and specifically through the plurality of holes 131a included in the sample inlet 131. As the sample introduced into the chamber 141 spreads over approximately the entire surface of the detector 111, the sample is readily detected. The plurality of holes 131a may be arranged in an approximate circle shape on the top plate 130, specifically in the opening part 132 (see FIG. 1). For example, the plurality of holes 131a may be arranged along the circumferences of circles having different diameters between the center and outer circumference of the opening part 132, and/or spirally from the center to the outer circumference of the opening part 132. Or the plurality of holes 131a may be arranged in a square shape on the top plate 130, specifically in the opening part 132. For example, the plurality of holes 131a may be arranged in an ‘n×n’ array, such as a 5×5 array, with the corners of the array truncated due to the circular shape of the opening part 132. That is, three of the plurality of holes 131a may be arranged at each of the uppermost, lowermost, leftmost, and rightmost positions of the array. In this manner, the sample inlet 131 has the plurality of holes 131a in an n×n or n×m layout in the opening part 132. However, the present disclosure is not limited thereto, and the plurality of holes 131a may be disposed, arranged, shaped, and/or formed in any suitable and/or similar manner.

In an embodiment of the present disclosure, the chamber 141 is shaped into a circle and thus the opening part 132 has a virtual circular outline corresponding to the size of the chamber 141. The chamber 141 may have a diameter of 3 to 8 mm, however, the present disclosure is not limited thereto, and the chamber 141 may have any suitable diameter. Then the opening part 132 may also have a diameter of 3 to 8 mm at a position corresponding to the position of the chamber 141. If the chamber 141 and the opening part 132 have a diameter of 3 to 8 mm, each of the plurality of holes 131a formed in the opening part 132 may have a diameter of 10˜900 μm, however, the present disclosure is not limited thereto, and each of the plurality of holes may have any suitable diameter. When the sample is spotted in the opening part 132, the distance d between the center of each hole from among the plurality of holes 131a and the center of its adjacent hole 131a is preferably 0.5 mm or less so that most of the spotted sample may be introduced into the chamber 141 on the detector 111 through the plurality of holes 131a. However, the size of the chamber 141, the opening part 132, and the plurality of holes 131a are not limited to the specific values in the embodiment of the present disclosure. The size of the chamber 141, the opening part 132, and the plurality of holes 131a may vary according to the size of the biosensor 100, the amount of a sample provided to the detector 111, the size of the detector 111, and/or the like.

All of the plurality of holes 131a are disposed inside the opening part 132. If the chamber 141 and the opening part 132 are circular, then the holes 131a reside inside the virtual outer circumference of the opening part 132. If the holes 131a are arranged in a circle, then the holes 131a are formed along the circumferences of circles having different diameters, and are disposed apart from each other by a predetermined distance. If the holes 131 a are arranged in a square, then the square has an n×n layout with the outer holes 131a confined inside the opening part 132. That is, the holes 131a are arranged in a 5×5 square, with only three holes 131a positioned at each of the uppermost, lowermost, leftmost, and rightmost positions.

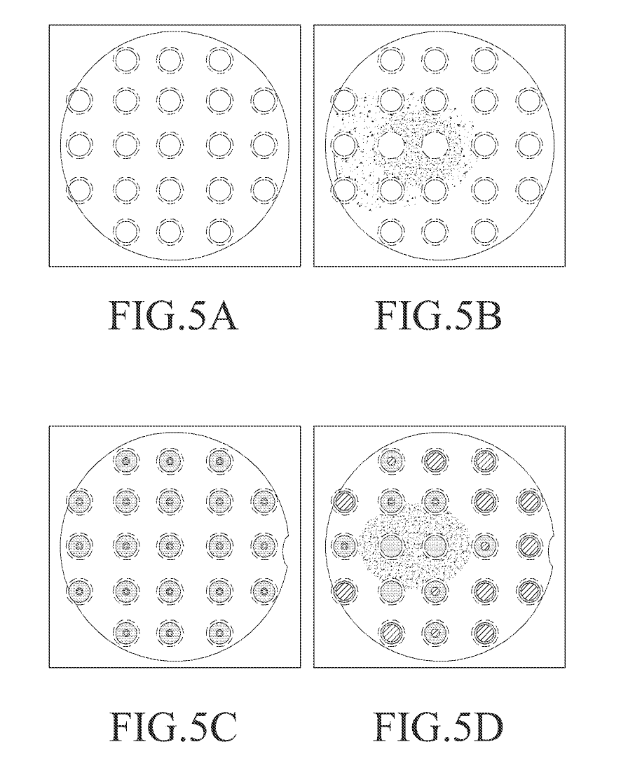

FIGS. 5A, 5B, 5C, and 5D illustrate a spotted state of a sample on the biosensor illustrated in FIG. 2 according to an embodiment of the present disclosure.

Referring to FIGS. 5A, 5B, 5C, and 5D, the sample inlet 131 having the plurality of holes 131a is formed on the top of the biosensor 100, which is formed by stacking the insulation layer 120, the spacer 140, and the top plate 130 sequentially on the base plate 110. When a user spots a prepared sample on the sample inlet 131, the sample is introduced into the chamber 141 between the top plate 130 and the base plate 110 through some of the plurality of holes 131a. At the same time, the air filled in the chamber 141 is discharged through the plurality of holes 131a in which the sample is not spotted or through the vent hole 142, along with the introduction of the sample. Thus all of the sample spotted on the sample inlet 131 may be introduced into the space of the chamber 141. The sample spotted in the sample inlet 131 is readily introduced into the chamber 141 through the holes 131, thus filling in the space of the chamber 141 and then the detector 111. The detector 111 is filled with the sample introduced into the chamber 141, thus analyzing information about the sample.

As the sample is spotted in the sample inlet 131 formed on the top plate 130 which is large, sample spotting may be easier. In addition, since the sample is all introduced into the chamber 141, sample loss and/or sample damage may be prevented, which might otherwise be caused by overflow of the sample beyond the sample inlet 131.

As is apparent from the above description, the sample inlet is provided on the top surface of the top plate. Thus, when a user places a sample on the biosensor, the user may confirm the sample visually. Further, since the sample inlet is formed in the top plate, the sample may be easily introduced into the chamber. As the prepared sample is all, or in other words, entirely introduced into the chamber through the holes, a sufficient amount of the sample may be provided to the detector, thereby increasing user convenience.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A biosensor comprising:
a base plate including a detector configured to detect a sample through an electrode;
an insulation layer disposed on a top surface of the base plate;
a top plate mounted over the base plate and including a sample inlet that introduces the sample onto the detector; and
a spacer interposed between the top plate and the insulation layer and forming a chamber.

2. The biosensor of claim 1, wherein the sample inlet includes a plurality of holes that penetrate the top plate so as to face the chamber.

3. The biosensor of claim 2, wherein the spacer includes at least one vent hole that communicates with the chamber and, when the sample is introduced, discharges air from the inside of the chamber.

4. The biosensor of claim 2, wherein the plurality of holes are arranged in a circle on the top plate in correspondence with a position of the chamber.

5. The biosensor of claim 2, wherein the plurality of holes are arranged in a square on the top plate in correspondence with a position of the chamber.

6. The biosensor of claim 2, wherein a distance between a center of one of the plurality of holes and a center of an adjacent one of the plurality of holes is 0.5 mm or less.

7. The biosensor of claim 1, wherein the sample inlet, the chamber, and the detector communicate with one another vertically.

8. The biosensor of claim 2, wherein, if the sample is spotted on a top surface of the top plate, then the sample is introduced into the chamber through the sample inlet and provided to the detector.

9. The biosensor device of claim 2, wherein the chamber is shaped into a circle.

10. The biosensor of claim 9, wherein the chamber has a diameter of 3 mm to 8 mm, and
wherein each of the plurality of holes is formed to have a diameter of 10 μm to 900 μm in an area having a diameter of 3 mm to 8 mm on the top plate.

11. The biosensor of claim 9, wherein the insulation layer includes a hole formed in correspondence with a position of the chamber in order to bring the sample introduced into the chamber into contact with the detector.

12. A biosensor comprising:
a sample inlet including a plurality of holes on a top surface of a top plate of the biosensor,
wherein a sample is transferred to a detector of a base plate, which is disposed under the sample inlet, through the plurality of holes.

13. The biosensor of claim 12, wherein a spacer is interposed between the top plate and the base plate in order to form a chamber that accommodates the sample on the detector, and
wherein an insulation layer is formed on the base plate.

14. The biosensor of claim 13, wherein the insulation layer includes a hole to bring the sample, which is accommodated in the chamber, into contact with the detector.

15. The biosensor of claim 13, wherein the chamber includes a vent hole that discharges air from the chamber to the outside of the biosensor.

16. A biosensor comprising:
a top plate and including a sample inlet that introduces a sample into the biosensor;
a base plate mounted under the top plate and including a detector configured to analyze the sample using an electrode disposed on the base plate; and
a spacer disposed between the base plate and the top plate, and including a vent hole that exhausts air when the sample is introduced into the biosensor via the sample inlet.

17. The biosensor of claim 16, wherein the sample inlet includes a plurality of holes that penetrate through the top plate so as to allow the sample to be disposed on the detector.

18. The biosensor of claim 16, wherein the spacer includes a chamber that is disposed over the detector so as to collect the sample over the detector.

19. The biosensor of claim 16, further comprising an insulation layer disposed between the base plate and the spacer,
wherein the insulation layer includes another vent hole that exhausts air when the sample is introduced into the biosensor via the sample inlet, and
wherein the insulation layer includes a hole disposed below and corresponding to the chamber of the spacer so as to collect the sample over the detector.
